(19) United States
(12) Patent Application Publication
(10) Pub. No.: US 2016/0145038 A1
(43) Pub. Date: May 26, 2016

(54) POD FOR BEVERAGE MACHINE

(71) Applicant: Starbucks Corporation dba Starbucks Coffee Company, Seattle, WA (US)

(72) Inventors: Dan Apone, Seattle, WA (US); Izaak Koller, Seattle, WA (US); Michael Cummer, Seattle, WA (US)

(21) Appl. No.: 14/941,165

(22) Filed: Nov. 13, 2015

Related U.S. Application Data
(60) Provisional application No. 62/082,452, filed on Nov. 20, 2014.

(51) Int. Cl. B65D 85/804; B65B 29/02; A23F 5/26; A47J 31/40; A47J 42/38

(52) U.S. Cl. CPC B65D 85/8046; A47J 31/407; A47J 42/38; A23F 5/262; B65B 29/02

(57) ABSTRACT

Various beverage preparation systems, beverage pods, and beverage preparation machines are described. In some embodiments, a beverage pod for the preparation of a single serving of a beverage includes a body portion containing whole coffee beans. The pod can include a movable grinding element positioned in the body portion. The movable grinding element can be configured to move relative to the body portion and to grind the coffee beans into coffee grounds inside the beverage pod. The pod can include an inlet configured to receive an introduction of liquid. The liquid can mix with the coffee grounds to prepare the beverage inside the pod. The beverage can be dispensed through an outlet, such as directly to a cup.

### CROSS REFERENCE

This application claims a priority benefit under 35 U.S.C. §119 of U.S. Patent Application No. 62/082,452, filed Nov. 20, 2014, the entirety of which is hereby incorporated by reference herein.

### FIELD

The present disclosure relates to pods containing a single serving of a beverage component or precursor for producing a beverage when fluid is introduced into the pod. The pod can be configured for use with single-serve beverage preparation machines.

### DESCRIPTION OF CERTAIN RELATED ART

Single-serve beverage machines are devices that are designed to produce a single serving, or sometimes a single cup, of a desired beverage. In comparison to other types of beverage machines (such as drip coffee makers having a multi-cup carafe), single-serve beverage machines can enhance convenience by reducing the time to prepare the beverage.

Some single-serve beverage machines use a pod (also called a cartridge or capsule) containing one or more beverage components or precursors to produce the beverage. Generally, such pods are received in the single-serve beverage machine, are used to produce the single serving of the beverage, and are subsequently manually removed from the machine and discarded.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 schematically illustrates an embodiment of a beverage preparation system comprising a beverage preparation machine and a beverage pod.

FIG. 2A illustrates a cross-sectional side view of an embodiment of the beverage pod of FIG. 1.

FIG. 2B illustrates a composite cross-sectional side view of the pod of FIG. 2A received in an embodiment of the beverage preparation machine of FIG. 1, with the left portion of the figure showing a state before grinding, and the right portion of the figure showing a state during or after grinding.

FIG. 3 schematically illustrates an example method of preparing a beverage with the beverage preparation system of FIG. 1.

FIG. 4A illustrates a cross-sectional side view of another embodiment of the beverage pod of FIG. 1.

FIG. 4B illustrates a composite cross-sectional side view of the pod of FIG. 4A received in an embodiment of the beverage preparation machine of FIG. 1, with the left portion of the figure showing a state before grinding, and the right portion of the figure showing a state during or after grinding.

FIG. 4C illustrates the pod and beverage preparation machine of FIG. 4B in a state during or after a tamping operation.

FIG. 5 illustrates a composite cross-sectional side view of another embodiment of the beverage pod of FIG. 1 received in an embodiment of the beverage preparation machine of FIG. 1, with the left portion of the figure showing a state before grinding, and the right portion of the figure showing a state during or after grinding.

FIGS. 6A-6H illustrate schematic views of embodiments of outlet valves that can be included in any of the beverage pod embodiments.

FIGS. 7A-7D illustrate partial cross-sectional side views of an embodiment of the beverage pod of FIG. 1, received in an embodiment of the beverage preparation machine of FIG. 1, during various states of a collapsing operation.

### DETAILED DESCRIPTION OF CERTAIN EMBODIMENTS

Various beverage preparation systems, beverage pods, and beverage preparation machines (also called brewer machines) are described below to illustrate various examples that may be employed to achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein. Also, although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

### Overview

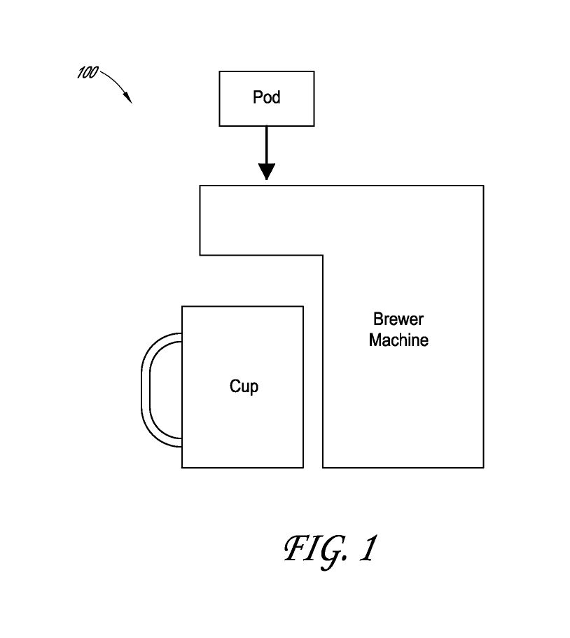

FIG. 1 schematically illustrates an embodiment of a beverage preparation system 100. As shown, the system 100 can include a beverage pod and a beverage preparation machine. The beverage pod can be received in the beverage preparation machine, such as by loading through a top or side of the beverage preparation machine. During a beverage preparation operation, the beverage preparation machine can introduce fluid (e.g., a liquid, such as water) into the beverage pod to produce a beverage in the pod. The beverage can flow out of the pod for consumption, such as into a cup or other vessel. In certain embodiments, the beverage is dispensed directly from the pod into the cup, without touching the beverage preparation machine. This can reduce or avoid the need to clean portions of the beverage preparation machine.

In various embodiments, the beverage pod includes whole coffee beans. The beverage pod can be configured to grind the whole coffee beans inside the beverage pod, such as with a grinding mechanism contained inside the pod. This allows the whole coffee beans to be ground just prior to (e.g., less than about 5 minutes before) preparing the beverage, which can reduce or avoid the loss of flavor and aroma, and/or change in flavor profile, that can occur when whole coffee beans are ground weeks, days, or even just hours before preparing the beverage. Also, grinding the whole coffee beans inside the pod can solve problems associated with sealed pods that include pre-ground coffee (e.g., in which the beans are not ground inside the pod). For example, it can be difficult to determine when to grind whole coffee beans at the correct level of freshness so that degassing can occur before the pre-ground coffee is sealed inside the pod, so that the oxygen is not present inside the sealed pod. Grinding the whole coffee beans in the pod can reduce or avoid this problem. In various embodiments, the coffee grounds are retained in the beverage pod at the conclusion of the beverage preparation operation.

Certain embodiments and examples are disclosed below in the context of coffee beverages, such as brewed coffee and/or espresso beverages. However, the various aspects of this disclosure can be used in other contexts as well, such as tea or other types of beverages and/or foods. Moreover, while the embodiments and examples disclosed below are in the context of single-serve beverage pods, certain features may also be applied to multiple-cup applications.

Certain Pods with Descending Grinders

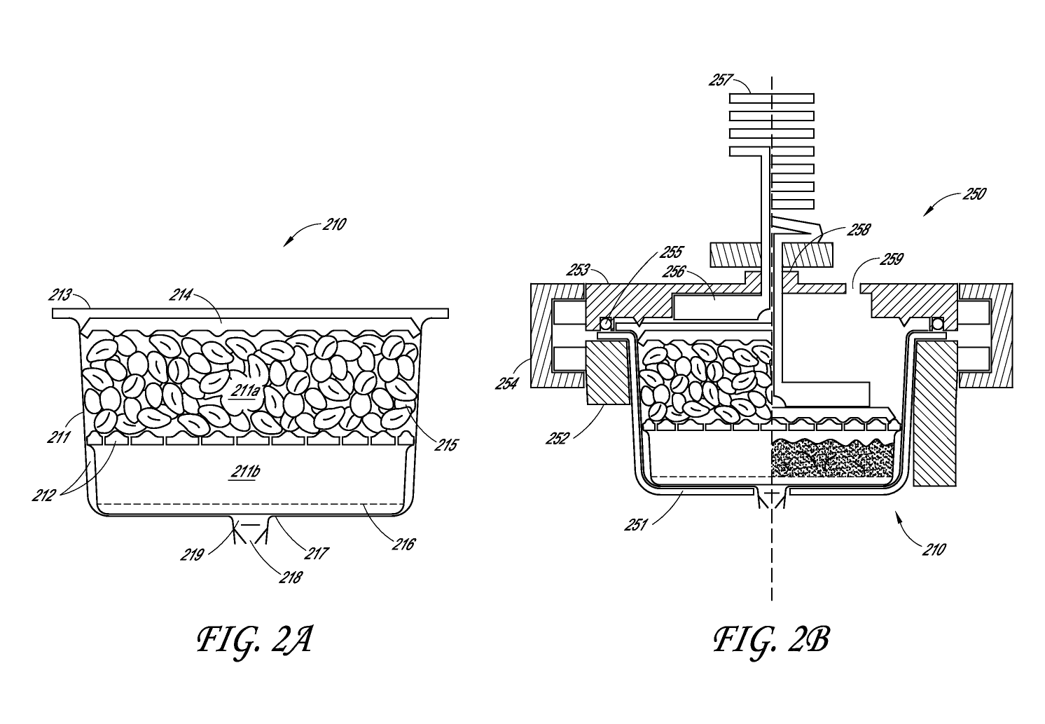

FIG. 2A illustrates a cross-sectional side view of an embodiment of a beverage pod 210 that can be used in the system 100. As shown, the pod 210 can include a body portion 211. Some variants of the body portion 211 have a generally cylindrical or gradually tapered shape (e.g., generally frustoconical). However, other shapes can be used without departing from the scope of this disclosure. The pod 210 can be made of any suitable material, such as plastic, metal, wood, bio-degradable polymers, etc. In some embodiments, some or all of the pod 210 is recyclable, biodegradable, reusable, and/or compostable. For example, the body portion 211 can be made of polylactic acid. As shown, the body portion 211 can define an internal chamber 211a.

A beverage component or precursor, such as whole coffee beans 215, can be located in the internal chamber 211a. In various implementations, the whole coffee beans 215 are roasted. In some embodiments, the beverage component or precursor includes coffee beans that are partially whole (e.g., split about in half or about in quarters) and/or are chopped (e.g., into pieces with an average or median size of at least about 2 mm). As discussed in more detail below, in various embodiments, the coffee beans are ground inside the pod 210. In some embodiments, the ground coffee is retained inside the pod 210, even after a beverage preparation procedure has been completed. Certain embodiments are configured to enable the coffee beans in the pod 210 to be viewed from a vantage point outside the pod 210. For example, the pod 210 can include a window or other transparent or semi-transparent region, such as in the body portion 211.

In various embodiments, the pod 210 can be configured to preserve freshness and/or to reduce the likelihood of degradation (e.g., oxidation) of the beans 215. For example, the internal chamber 211a of the pod 210 can have an environment that is generally oxygen free. In some implementations, oxygen or ambient air in the internal chamber 211a is replaced with a generally inert gas, such as nitrogen or another generally non-reactive gas. In some pods 210, oxygen or ambient air in the internal chamber 211a is replaced with a combination of nitrogen and carbon dioxide. Some pods 210 have an internal chamber 211a that is under a vacuum (e.g., less than about 1 bar and/or greater than or equal to about 0.1 bar).

Certain embodiments include a cover, such as an upper seal 213. The upper seal 213 can be sealed across a top surface of the body portion 211 to protect the contents of the pod 210, such as by inhibiting or preventing air from entering internal chamber 211a prior to use. In some embodiments, the upper seal 213 comprises a plastic film, fabric, metal foil, or other type of membrane. In certain variants, the upper seal 213 is configured to be removed (e.g., peeled off from the body portion 211), such as prior to the pod 210 being inserted into the beverage preparation machine. In some implementations, the upper seal 213 is configured to be breached (e.g., opened, pierced, torn, ripped ruptured, or otherwise beached), such as just prior to or during insertion in the beverage preparation machine, or during a beverage preparation operation (e.g., during a grinding process). In some embodiments, the pod 210 is positioned in the beverage preparation machine in an upright orientation (such as the orientation shown in FIG. 2A). In some variants, the pod 210 is positioned in the beverage preparation machine in a sideways orientation (such the orientation shown in FIG. 2A rotated about 90° clockwise or counterclockwise), or in an angled orientation (such the orientation shown in FIG. 2A rotated between about 30° and about 60° clockwise or counterclockwise)

The pod 210 can include a first grinding structure, such as a stationary grinding element 212 (e.g., a disk). In some embodiments, the stationary grinding element 212 generally does not move relative to the body portion 211 and/or the whole coffee beans 215. As shown in FIG. 2A, the stationary grinding element 212 can be positioned at a lower or intermediate location between the upper and lower portions of the pod 210 and/or below the whole coffee beans 215. In certain variants, the stationary grinding element 212 can be positioned at an upper location between the upper and lower portions of the pod 210 and/or above the whole coffee beans 215.

The stationary grinding element 212 can be configured to facilitate grinding of the whole coffee beans 215. For example, the stationary grinding element 212 can comprise a convoluted surface, which can promote grinding of beans when the beans are moved relative to the convoluted surface. In some variants, the stationary grinding element 212 comprises other grinding features, such as one or more burrs, bumps, ridges, grooves, channels, teeth, or other features that can facilitate grinding of the whole coffee beans. As illustrated, in certain implementations, the grinding element 212 comprises a plate with the convolutions and/or other grinding features extending therefrom. As shown, in some embodiments, the stationary grinding element 212 is supported by a portion of the body portion 211, such as by one or more radially inwardly extending ribs.

In some implementations, the stationary grinding element 212 includes one or more openings. The openings can be configured to allow ground coffee beans (also called “ground coffee”) to pass through the stationary grinding element 212, while inhibiting or preventing passage of the whole beans 215. As shown, in some embodiments, the openings are distributed generally equally across the extent of the stationary grinding element 212. In other embodiments, the openings are unequally distributed. For example, in some embodiments, the openings are positioned only at a periphery of the stationary grinding element 212 and/or only at a central portion of the stationary grinding element 212.

The pod 210 can include a second grinding structure, such as a movable grinding element 214 (e.g., a disk). In some embodiments, the movable grinding element 214 can be positioned at an upper or intermediate location between the upper and lower portions of the pod 210 and/or above the whole coffee beans 215. In certain variants, the movable grinding element 214 can be positioned at a lower location between the upper and lower portions of the pod 210 and/or below the whole coffee beans 215.

The movable grinding element 214 can be configured to facilitate grinding of the whole coffee beans 215. For example, the movable grinding element 214 can comprise a convoluted surface, which can promote grinding of beans when the beans are moved relative to the convoluted surface. In some variants, the movable grinding element 214 comprises other grinding features, such as one or more burrs, bumps, ridges, grooves, channels, teeth, or other features that can facilitate grinding of the whole coffee beans. As illustrated, in certain implementations, the movable grinding element 214 comprises a plate with the convolutions and/or other grinding features extending therefrom.

The movable grinding element 214 can be configured to move (e.g., vibrate, rotate, translate, oscillate, tilt, or otherwise move) to facilitate grinding of the whole coffee beans 215. For example, as discussed in further detail below, the movable grinding element 214 can move relative to the stationary grinding element 212 and/or the whole beans 215. This can grind the whole beans 215 against one or both of the grinding elements 212, 214, which can result in the whole beans being converted into coffee grounds. In various embodiments, the grinding action occurs at and/or between the grinding elements 212, 214. For example, in certain embodiments, the grinding elements 212, 214 together form a bun grinder that grinds the whole beans 215, such as by the movable grinding element 214 rotating relative to the stationary grinding element 212.

As shown in FIG. 2A, the movable grinding element 214 can be positioned at an upper portion of the pod 210 and/or above the whole coffee beans 215. As discussed in more detail below, in some implementations, the movable grinding element 214 can move generally vertically. This can aid in compensating for space created as the whole beans 215 are ground and/or as the grounds pass through the openings in the stationary grinding element 212. In some embodiments, the vertical movement of the movable grinding element 214 can aid in applying vertical pressure on the whole coffee beans 215, which can increase the force applied to the whole beans and facilitate grinding. Certain embodiments include the movable grinding element 214 but not the stationary grinding element 212.

In some embodiments, the pod 210 includes a third grinding element. For example, an internal section of the body portion 211 can include one or more features to facilitate grinding of the whole coffee beans 215. In some embodiments, the internal section of the body portion 211 includes a convoluted surface and/or includes bumps, ridges, grooves, channels, teeth, or other features. In various embodiments, the movable grinding element 214 moves relative to the internal section of the body portion 211, which can grind a portion of the whole beans 215 against the internal section of the body portion 211. In certain embodiments, the pod 210 is configured such that the grinding action occurs by a compressive and/or frictional force applied to the whole coffee beans 215 by the movable grinding element 214 and a wall (e.g., a sidewall or bottom) of the pod 210. In some embodiments, the whole coffee beans 215 are ground against the one or more radially inwardly extending ribs.

In certain implementations, the pod 210 includes a filter 216. The filter 216 can be attached to the body portion 211. As shown, the filter 216 can be positioned below a second internal chamber 211b of the pod 210, which can be located below the stationary grinding element 212. The filter 216 can be configured to inhibit or prevent coffee grounds from exiting the pod 210, such as when coffee grounds pass through the openings in the stationary grinding element 212 and into second internal chamber 211b of the pod 210 and/or during mixing of the coffee grounds with liquid. In various embodiments, all or substantially all (e.g., at least about 99%) of the coffee grounds are retained in the pod 210 after the beverage preparation operation has been completed and/or after the beverage has been dispensed from the pod 210.

The filter 216 can include a base substrate with a plurality of holes, such as an etched stainless steel plate. In certain implementations, the filter 216 includes a web of woven or non-woven fibers. In certain embodiments, the fibers are organized, such as in a generally regular pattern or mesh. Some variants have a web of generally randomly distributed fibers. The filter 216 can include a single layer or multiple layers. For example, some embodiments have at least two layers of fibers. Certain variants have a “sandwiched” configuration in which a third layer (or a fourth layer, fifth layer, or more) is positioned between the first and second layers. In some implementations, peripheries of the first and second layers are generally coupled together, such as by thermal bonding. In various embodiments, the layers can be the same or different. For example, a first layer can be made of a first type (e.g., fiber size, material, woven or non-woven, or otherwise) and the second layer can be a different type (different in at least one of fiber size, material, woven or non-woven, or otherwise compared to the first type). In some variants, the first and second layers are the same type and a sandwiched third layer is a different type.

With continued reference to FIG. 2A, the pod 210 can include an outlet aperture, which can be a restrictor 217. The restrictor 217 can be configured to restrict, hamper, or otherwise limit the discharge of liquid out of the pod 210. In some embodiments, limiting the discharge of liquid from the pod 210 can facilitate creating a pressure increase inside the cartridge 200, which can aid in the production of certain beverages (e.g., espresso) and/or can aid in compensating for certain inconsistencies in the beverage component or precursor (e.g., due to variations in the grind, tamping, settling or disruption during shipping, or otherwise). In some implementations, the restrictor 217 is configured to provide, and/or to facilitate the creation of, at least about 9 bars of pressure in the pod 210.

As illustrated, the restrictor 217 can be substantially smaller (e.g., in minimum inside diameter) than the minimum inside or outside diameter of the body portion 211 of the pod 210. For example, the ratio of the diameter of the restrictor 217 compared to the minimum inside diameter of the body portion 211 can be at least about: 1:5, 1:10, 1:15, 1:20, 1:25, 1:30, 1:40, ratios between the aforementioned ratios, or otherwise. As shown, some implementations include a single restrictor 217. Some other variants include a plurality of restrictors 217. As shown, the restrictor 217 can be positioned in the generally radial center of the pod 210. In certain embodiments, the restrictor 217 is offset from the center. In some embodiments, the restrictor 217 is generally conical or generally shaped as a nozzle. In certain variants, the inlet of the restrictor 217 is generally abutted with the filter 216. In various embodiments, the restrictor 217 has no moving parts.

In some embodiments, the pod 210 includes a dispensing portion, which can be configured to dispense a beverage from the pod 210. The dispensing portion can be in fluid communication with and/or downstream of the restrictor 217. In some implementations, as is discussed below, the beverage is dispensed from the dispensing portion directly into a cup or other vessel. This can avoid the beverage contacting surfaces of the beverage preparation machine, which in turn can reduce or avoid the need to clean portions of the beverage preparation machine. For example, in certain variants, the beverage does not travel through a nozzle of the beverage preparation machine.

In certain embodiments, the dispensing portion includes a directing element, such as a collimator 218. In some variants, the collimator 218 aids in controlling the flow of beverage out of the pod 210, such as by straightening the flow. In certain variants, the collimator 218 facilitates a generally laminar flow of the beverage out of the pod 210. In some implementations, the collimator 218 inhibits or prevents the beverage from gushing, sputtering, and/or spraying out of the pod 210. In some embodiments, during dispensation of the beverage from the pod 210 into a cup, substantially all (e.g., at least about 99%) of the beverage enters the cup and/or substantially none (e.g., less than about 0.01%) of the beverage impacts the beverage preparation machine. In some embodiments, the collimator 218 includes a plurality of protrusions within an outlet spout of the pod 210. In certain variants, the collimator 218 includes a plurality of passages, with each of the passages having a length that is multiple times the diameter of the passage, such as at least about: 3 times, 5 times, 10 times, 15 times, values between the aforementioned values, or other values.

FIG. 2A also shows that the pod 210 can include an outlet valve 219. In some embodiments, the outlet valve 219 acts as an air barrier. For example, the outlet valve 219 can inhibit or prevent air from passing through the outlet aperture and/or the outlet spout, which could cause oxidation or other spoliation of the whole beans 215 in the pod 210. The outlet valve 219 can be configured to open during the beverage preparation process, such as to allow the beverage to be dispensed out of the pod 210. In various embodiments, the outlet valve 219 opens automatically during the beverage preparation process, or in response to the pod 210 being inserted into the beverage preparation machine. As is discussed in more detail below, certain variants of the outlet valve 219 open automatically based on temperature, mechanical force, and/or pressure. For example, in some implementations, the outlet valve 219 opens in response to the pressure in the pod 210 reaching a threshold pressure, such as at least about: 5 bars, 7 bars, 9 bars, 11 bars, values between the aforementioned values, or other values.

FIG. 2B illustrates a composite cross-sectional side view of the pod 210 received in a beverage preparation unit (also called a brewing unit 250) of the beverage preparation machine. The left portion of the figure shows the pod 210 and brewing unit 250 in a state before grinding, such as just after the pod 210 has been inserted into the brewing unit 250. The right portion of the figure shows the pod 210 and brewing unit 250 in a state during or after grinding.

In various embodiments, the brewing unit 250 includes a receiving portion, such as a pod support nest 251. The nest 251 can be sized and configured to receive the pod 210. For example, the nest 251 can have a shape that generally mates with and/or corresponds to the shape of a portion (e.g., the sidewalls and bottom) of the body portion 211 of the pod 210. In some implementations, the nest 251 provides support for the pod 210. For example, the nest 251 can provide sufficient structural rigidity and/or integrity such that the pod 210 does not unintentionally rupture or explode when the pod is subjected to elevated pressures during the brewing process, such as at least about 9 bars. As illustrated, the nest 251 can include an opening configured to receive the outlet spout of the pod 210. In some variants, the outlet spout extends through the opening in the nest 251, such that liquid flowing out of the pod 210 via the outlet spout does not contact the nest 251.

In some implementations, the brewing unit 250 includes a first nest support member, such as a lower support 252. The lower support 252 can provide structural support for the nest 251. In some variants, during the beverage preparation operation, the lower support 252 transmits forces from the nest 251 to other portions of the beverage preparation machine, such as forces that are applied to the nest 251 (e.g., via the pod 210) during the process of loading the pod 210 into the brewing unit 250, during the brewing process, and/or during a collapsing process (as is discussed in more detail below).

As further shown in FIG. 2B, the brewing unit 250 can include a second nest support member, such as an upper support 253. In some implementations, the upper support 253 can engage with the lower support 252 to form a brew chamber, in which the beverage is prepared. As shown, the upper support 253 can serve as a top surface of the brew chamber. The upper support 253 can be configured to move, so as to allow the pod 210 to be inserted into the nest 251. For example, in some embodiments, the upper support 253 translates generally vertically, rotates generally horizontally, and/or flips out of the way to allow insertion of the pod 210 into the brewing unit 250.

In certain implementations, one or both of the supports 252, 253 include features configured to open (e.g., pierce, penetrate, rupture, rip, or otherwise open) the upper seal 213 of the pod 210. For example, as shown, the upper support 253 can include a piercing member (e.g., a tooth, projection, rib, needle, or other piercing structure) that is configured to open the upper seal 213 of the pod 210. In various embodiments, the opening of the upper seal 213 of the pod 210 permits liquid, such as hot water, to enter the inside of the pod 210 for preparation of the beverage. In certain variants, the piercing member contacts, but does not pierce, the upper seal 213. For example, the piercing member can score the upper seal 213, which can aid in opening the upper seal 213 during a descending movement of a pod engagement drive of the brewing unit 250, as is discussed in greater detail below. In some embodiments, the piercing member is configured so as to not pierce and/or not contact the movable grinding element 214 in the pod 210, as is shown in FIG. 2B.

The brewing unit 250 can include a securing member, such as a nest clamp 254. In the embodiment illustrated, the nest clamp 254 can secure the supports 252, 253 together during the beverage preparation operation. This can provide structural strength for the supports 252, 253, can decrease the chance of the supports 252, 253 moving relative to each other, and/or can reduce or eliminate leaks from the brew chamber during the beverage preparation operation. In some embodiments, the nest clamp 254 can be engaged (e.g., in a position securing the supports 252, 253 together) and disengaged (e.g., in a position in such that the supports 252, 253 can be moved relative to each other). For example, the nest clamp 254 can be engaged during the beverage preparation operation and disengaged prior to and/or after the beverage preparation operation, such as to facilitate loading and/or unloading of the pod 210 from the brewing unit 250. In some embodiments, the nest clamp 245 is actuated by the brewing unit 250 or by a user. In certain variants, the nest clamp 245 is driven by a cam and/or is twisted, such as with a threaded member.

Certain embodiments include a first sealing member 255, such as a grommet or o-ring. In some embodiments, the first sealing member 255 can provide a generally liquid tight and/or generally gas-tight seal during the beverage preparation operation, which can reduce or avoid leaks from the brew chamber. For example, as shown, the first sealing member 255 can sealingly engage between the supports 252, 253. In some variants, the first sealing member 255 sealingly engages between the upper support 253 and the upper seal 213 of the pod 210. In certain variants, the first sealing member 255 is part of the pod 210. For example, a compliant material could be formed (e.g., over-molded) around a portion of the pod 210 after the lid 213 is sealed to the pod 211.

With continued reference to FIG. 2B, the brewing unit 250 can include an assembly that engages with the pod 210, such as a pod engagement drive 256. The pod engagement drive 256 can engage (e.g., interface, interlock, or otherwise engage) with the movable grinding element 214 of the pod 210. For example, the pod engagement drive 256 can engage with a keyed, splined, or ribbed portion of the movable grinding element 214. In certain embodiments, one of the pod engagement drive 256 and the movable grinding element 214 includes a projection and the other of the pod engagement drive 256 and the movable grinding element 214 includes a corresponding recess, such that the projection can be inserted into the recess to matingly connect the pod engagement drive 256 and the movable grinding element 214. In certain embodiments, the movable grinding element 214 has an outer surface that engages pod engagement drive 256 and an inner surface that serves as the grinding surface. As shown, in some embodiments, the pod engagement drive 256 includes engagement features, such as an outwardly extending flange or shoulder. This can increase the surface area in contact between the pod engagement drive 256 and the movable grinding element 214.

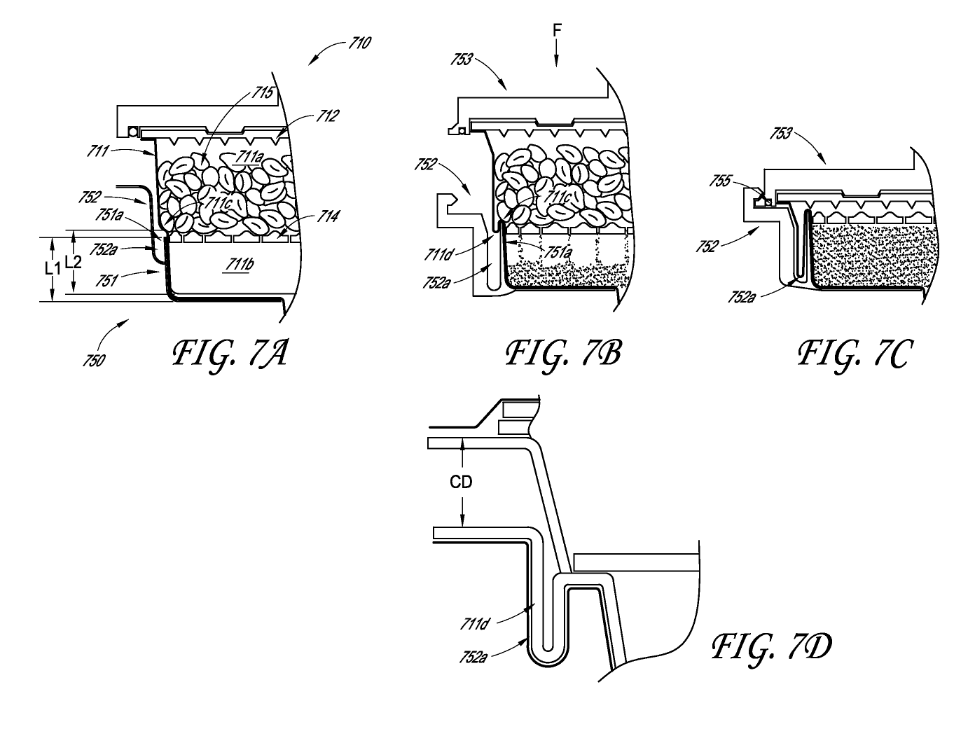

The pod engagement drive 256 can be configured to transmit energy (e.g., kinetic energy) to the movable grinding element 214. For example, the pod engagement drive 256 can be configured to cause the movable grinding element 214 to move (e.g., vibrate, rotate, oscillate, tilt, or otherwise move). As discussed above, such movement of the movable grinding element 214 can facilitate grinding of the whole coffee beans 215. As shown on the right side of FIG. 2B (and also shown in FIG. 7B), the ground coffee can pass through the openings (e.g., holes or slots) in the stationary grinding element 212 and collect in the second chamber 211b of the pod 210.

In some embodiments, the pod engagement drive 256 can move generally vertically. For example, as shown in the right side of FIG. 2B, the pod engagement drive 256 can descend relative to the upper seal 213 and/or stationary grinding element 212 of the pod 210. In some embodiments, as is shown in the right side of FIG. 2B, the pod engagement drive 256 descends into engagement (e.g., abutment) with the upper seal 213, which can break (e.g., tear or rupture) the upper seal 213 and open the pod 210.

In some embodiments, the upper seal 213 is configured to stretch and/or unfold. For example, the pod engagement drive 256 can descend into engagement with the upper seal 213, which can deflect a portion of the upper seal 213 relative to the beans 215 and/or one or both of the grinding elements 212, 214. Such delectability of the upper seal 213 can allow insertion of the pod engagement drive 256 into the pod 210 without breaching the upper seal 213. This can facilitate grinding of the whole beans 215 and/or tamping (as is discussed in more detail below) without breaching the upper seal 215. Some implementations have an upper seal 213 that does not separate, tear, or break away from the body portion 211 during a grinding and/or tamping operation. Some embodiments maintain the seal provided by the upper seal 213, such as by not breaching the upper seal 213 with a needle, spike, or the like. In certain variants, the upper seal 213 is resilient and/or can generally return to its initial position after deflecting. Additional details regarding pods with stretchable portions, or other features, can be found in U.S. Patent Application Publication No. 2014/0272018, filed Feb. 26, 2014, which is incorporated herein by reference in its entirety. Further details regarding certain pods can be found in U.S. Patent Application Publication No. 2015/0110929, filed Dec. 30, 2014, which is incorporated herein by reference in its entirety.

In certain implementations, the descending movement of the pod engagement drive 256 facilitates grinding. As shown in the right side of FIG. 2B, the descending movement of the pod engagement drive 256 can cause the movable grinding element 214 to descend relative to the stationary grinding element 212. For example, the pod engagement drive 256 can push the movable grinding element 214 downward and/or generally toward the stationary grinding element 212. This can aid in compensating for space created as the whole beans 215 are ground, such as space that is created as the whole beans 215 are ground and the ground coffee passes through the openings in the stationary grinding element 212. In some variants, the movable grinding element 214 is moved (e.g., downwardly) in such a way as to maintain a generally constant or increasing grinding pressure on the whole beans 215 during a portion of the grinding operation. Some implementations are configured to vary the grinding pressure (e.g., as a function or time, displacement of the movable grinding element 214, and/or a percentage of the whole beans 215 converted to coffee grounds). For example, some embodiments reduce the grinding pressure during a portion of (e.g., during an end stage) the grinding operation, which can facilitate the coffee grounds moving downward and/or through the openings in the stationary grinding element 212. In various implementations, the grinding pressure changes linearly or non-linearly (e.g., exponentially). Certain embodiments are configured to increase and decrease the grinding pressure. For example, some embodiments apply (e.g., push down with) an amount of force, then reduce the amount of force for a period of time, then increase the amount of force again.

As shown in the right side of FIG. 2B, in certain embodiments, the grinding surfaces 212, 214 can engage. For example, at or near an end of the grinding operation, the pod engagement drive 256 can move the movable grinding element 214 into abutment with the stationary grinding element 212. As is shown, in some variants, the grinding features of the grinding elements 212, 214 nest and/or engage together. For example, the grinding elements of the movable grinding element 214 can be received between the grinding elements of the stationary grinding element 212.

Certain implementations are configured to compress (e.g., tamp) the coffee grounds and/or to adjust (e.g., even-out, make consistent, level, smooth, etc.) the thickness of the coffee grounds. This can aid in the extraction of certain aroma and/or flavor compounds, which can result in an improved beverage. For example, for espresso-based beverages, compressing the ground espresso coffee beans can provide a beverage with an improved flavor profile. In some embodiments, in an end portion of the grinding process (e.g., near or after substantially all of the whole beans have been converted to coffee grounds) the pod engagement drive 256 can descend an additional distance into the pod 210. This can cause the movable grinding element 214 to exert a force on the stationary grinding element 212 in the direction of the bottom of the pod 210. In some embodiments, this can cause the stationary grinding element 212 to move (e.g., slide, bend, deflect, unfold, or otherwise move) toward the bottom of the pod 210, which can result in compression of the coffee grounds located in the second chamber 211b (e.g., between the stationary grinding element 212 and the bottom of the pod 210). In some embodiments, during the tamping operation, the movable grinding element 214 moves generally vertically only (e.g., does not also rotate relative to the stationary grinding element 212).

In some implementations, near or at the end of, or after, the grinding process, the pod engagement drive 256 ascends momentarily, which can to allow the coffee grounds to settle. The pod engagement drive 256 can then descend to tamp the coffee grounds. In certain embodiments, the ground coffee is tamped more than once, such as by the pod engagement drive 256 ascending and descending multiple times. In some variants, the pod engagement drive 256 descends a distance into the pod 210 and then stops and/or ascends a distance, then descends further into the pod 210 and then stops and/or ascends. In certain implementations, this can provide progressive tamping of the coffee grounds.

In certain embodiments, after the grinding and/or compressing operations have been completed, the pod engagement drive 256 and/or the movable grinding element 214 returns to an elevated position, such as is shown in the left side of FIG. 2B. This can facilitate removal of the pod 210 and/or insertion of another pod.

In some embodiments, the brewing unit 250 includes a biasing member 257, such as a spring (e.g., a helical coil spring, wave spring, belleville washer stack, or otherwise), linear actuator, pneumatic actuator, or hydraulic actuator. The biasing member 257 can provide biasing force (e.g., downward force) on the pod engagement drive 256. As shown, in some embodiments, the biasing member 257 biases a second sealing member 258, such as a resilient washer. The second sealing member 258 can form a seal between the pod engagement drive 256 and the upper support 253, which can reduce the chance of leaks.

In various embodiments, liquid can enter the brew chamber via an inlet port 259. In some embodiments, the inlet port 259 receives liquid from a reservoir (not shown). In certain variants, the liquid is heated (e.g., by a boiler) or cooled (e.g., by a refrigeration system). The liquid can be provided to the inside of the pod 210, to mix with the coffee grounds to form the beverage in the pod 210. In some implementations, the introduction of the liquid facilitates pressurizing the inside of the pod 210, such as up to a pressure of at least about 9 bars.

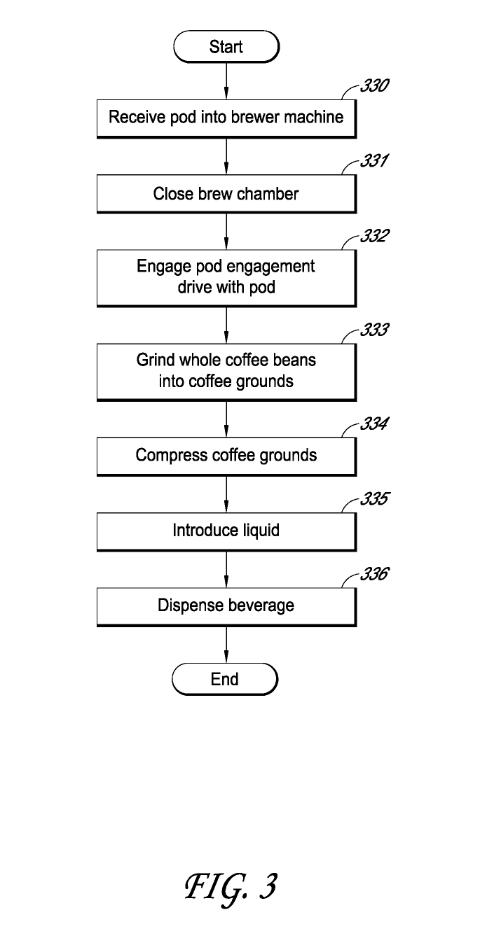

FIG. 3 schematically illustrates an example method 300 of preparing a beverage with the pod 210. As shown, the method can include block 330, which includes receiving the pod 210 in the beverage preparation machine, such as in the brew basket 250. The method can include closing the brew chamber, such as by closing a lid of the beverage preparation machine, as indicated in block 331. In some embodiments, the method includes engaging the pod engagement drive 256 with the pod 210, as shown in block 332. For example, the pod engagement drive 256 can be interfaced with a portion of the pod 210 that is connected with the movable grinding element 214, such that energy can be transferred from the pod engagement drive 256 to the movable grinding element 214.

As shown, in block 333, the method can include grinding (e.g., pulverizing) some or all of the whole coffee beans 215 into coffee grounds. For example, the whole beans 215 can be ground between the grinding elements 212, 214. In some embodiments, the method includes moving (e.g., vertically) the pod engagement drive 256 and/or moving (e.g., rotating) the movable grinding element 214 relative to the whole beans 215, the stationary grinding element 212, and/or the body portion 211 of the pod 210.

In certain embodiments, the method includes compressing (e.g., tamping) the coffee grounds, as indicated in block 334. For example, the movable grinding element 214 can abut with and/or apply a force on the stationary grinding element 212, which can move (e.g., slide, bend, deflect, unfold, or otherwise move) the stationary grinding element 212 relative to the coffee grounds. In some embodiments, this can compress the coffee grounds (e.g., between the stationary grinding element 212 and the bottom of the pod 210).

In certain embodiments, as shown in block 335, the method includes introducing liquid, such as hot water, into the pod 210. The liquid can interact with the coffee grounds to form a beverage, such as an espresso drink or brewed coffee, inside the pod 210. As indicated in block 336, the method can include dispensing the beverage. For example, in some implementations, the outlet valve 219 opens in response to a certain pressure being reached inside the pod 210 (e.g., at least about 9 bars), which allows the beverage to exit from the pod 210. In various embodiments, the method includes dispensing the beverage directly into a cup or other vessel and/or does not include passing the beverage through tubing or a dispensation nozzle of the beverage preparation machine.

Certain Pods with Ascending Grinders

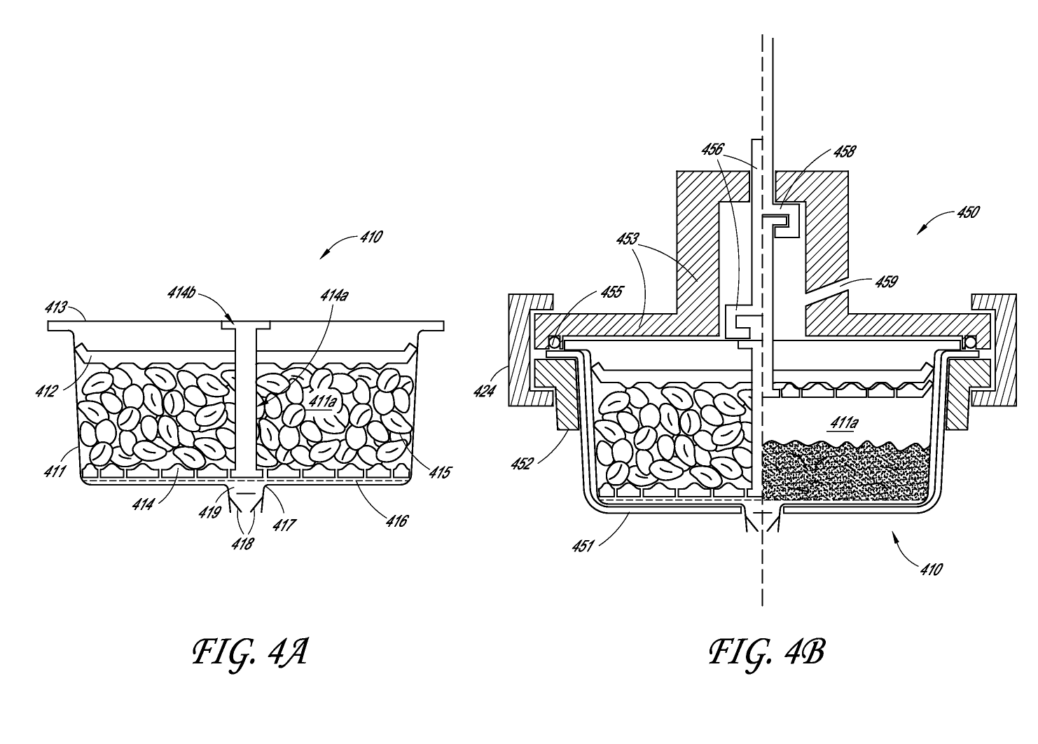

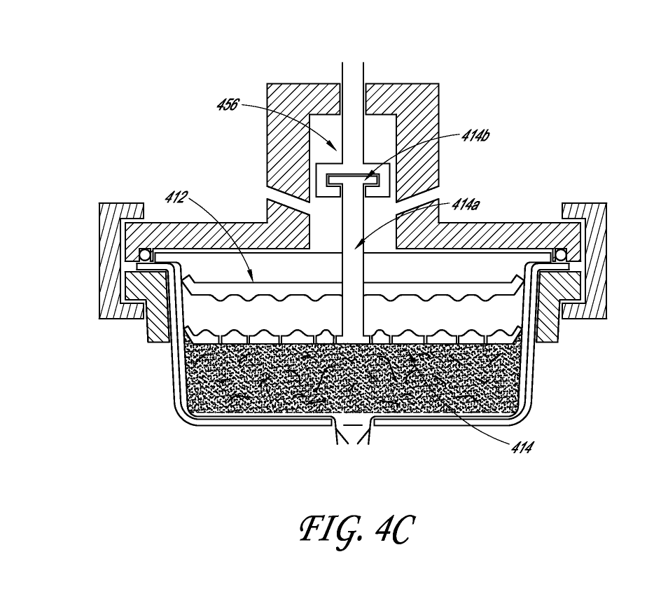

FIG. 4A illustrates a cross-sectional side view of another embodiment of a beverage pod 410 that can be used in the system 100. In many respects, the pod 410 resembles or is identical to the pod 210 discussed above, with certain differences described below. Thus, in describing certain features of the pod 410 that are similar or identical to the features in the pod 210, the last two digits of the reference numerals have been retained. For example, the pod 410 can include a body portion 411 that is similar or identical to the body portion 211 of the pod 200. This numbering convention generally applies to the remainder of the figures. Any feature, component, or step disclosed in any embodiment in this specification can be used in any other embodiment, or omitted.

As illustrated, the body portion 411 of the pod 410 can define an internal chamber 411a that includes whole coffee beans 415. An upper seal 413 can sealingly engage with an upper portion of the pod 410, such as by connecting with an outwardly extending flange of the body portion 411. As previously discussed, the upper seal 413 can be configured to be breached (e.g., by a piercing member of the beverage preparation machine) and/or removed (e.g., by the user peeling-off the upper seal 213). Various embodiments of the pod 410 include one or more of a filter 416, restrictor 417, directing element (e.g., a collimator 418), and outlet valve 419.

FIG. 4A also illustrates that the pod 410 can include a stationary grinding element 412 and a movable grinding element 414. The one or both of grinding surfaces 412, 414 can include a convoluted surface, which can promote grinding of beans when the beans are moved relative to the convoluted surface. The grinding surfaces 412, 414 can include grinding elements, such as one or more burrs, bumps, ridges, grooves, channels, teeth, or other features that can facilitate grinding of the whole coffee beans 415. In certain implementations, the stationary grinding element 412 is positioned in an upper portion of the pod 410 and/or above the whole beans 415. As shown, the stationary grinding element 412 can be spaced apart from the upper seal 413, such as being recessed within the body portion 411. In various embodiments, the grinding elements 412, 414 together can form a bun grinder, such as by the movable grinding element 414 rotating relative to the stationary grinding element 412.

In some embodiments, the movable grinding element 414 is initially (e.g., before the grinding operation) positioned below the whole beans 415 and/or the below stationary grinding element 412. In certain embodiments, the movable grinding element 414 includes one or more openings. The openings can be configured to allow ground coffee to pass through the movable grinding element 414, while inhibiting or preventing passage of the whole beans 415. As shown, in some embodiments, the openings are distributed generally equally across the extent of the movable grinding element 414. In other embodiments, the openings are unequally distributed. For example, in some embodiments, the openings are positioned only at a periphery of the movable grinding element 414 and/or only at a central portion of the movable grinding element 414.

As shown in FIG. 4A, the movable grinding element 414 can include a riser 414a, such as a rod or bar. As shown, in some embodiments, the riser 414a can connect (e.g., rigidly) with the grinding surface. The riser 414a can extend through the beans 415 and/or through the stationary grinding element 412. The riser 414a can connect with an engagement portion 414b, such as a flange. As discussed in more detail below, kinetic energy can be transferred to the movable grinding element 414 via the engagement portion 414b and the riser 414a and/or the movable grinding element 414 can be moved (e.g., upwardly) by moving the engagement portion 414b and the riser 414a.

FIG. 4B illustrates a composite cross-sectional side view of the pod 410 in an embodiment of a brewing unit 450. In many respects, the brewing unit 450 is similar or identical to the brewing unit 250 discussed above, with certain differences described below. The left portion of FIG. 4B shows the pod 410 and brewing unit 450 in a state before grinding, such as just after the pod 410 has been inserted into the brewing unit 450. The right portion of FIG. 4B shows the pod 410 and brewing unit 450 in a state during or after grinding.

As shown on the left side of FIG. 4B, the brewing unit 450 can include a nest 451, lower support 452, and upper support 453. Similar to the discussion above, a nest clamp 454 can secure the supports 452, 453 during a beverage preparation operation. A sealing member 455 can provide a generally liquid tight and/or generally gas-tight seal during the beverage preparation operation.

In various embodiments, the brewing unit 450 includes a pod engagement drive 456. The pod engagement drive 456 can engage (e.g., interface, interlock, or otherwise engage) with the engagement portion of the pod 410. For example, in the embodiment shown, the engagement portion of the pod 410 includes a flange and the pod engagement drive 456 includes a hook that selectively couples with the flange, such as by grasping a portion of the flange. As described above, the engagement portion 414b of the pod 410 is connected with a riser 414a that extends through the whole beans 415 and is connected with the movable grinding element 414. Thus, in certain embodiments, when the pod engagement drive 456 is coupled with the engagement portion of the pod 410, movement of the pod engagement drive 456 can be transferred to the movable grinding element 414. For example, as shown in the right side of FIG. 4B, ascending movement of the pod engagement drive 456 can result in ascending movement of the movable grinding element 414. For example, as can be seen in comparing FIGS. 4A and 4B, the movable grinding element 414 can move from a bottom portion of the internal chamber 411a to a top portion of the internal chamber 411a.

In various embodiments, the pod engagement drive 456 can transfer kinetic energy to the movable grinding element 414, such that the movable grinding element 414 moves (e.g., vibrates, rotates, oscillates, tilts, or otherwise moves) relative to the stationary grinding element 412 and/or the whole beans 415. This can facilitate grinding of the whole coffee beans 415. In various embodiments, the grinding action occurs at and/or between the grinding elements 412, 414. In some implementations, the coffee grounds can pass through the openings in the movable grinding element 414. This can allow the coffee grounds to move from above the movable grinding element 414 to below the movable grinding element 414 by force of gravity.

In various embodiments, as shown in the right side of FIG. 4B, the movable grinding element 414 is configured to ascend, such as during the grinding operation. For example, the pod engagement drive 456 can pull the movable grinding element 414 upward and/or generally toward the stationary grinding element 412. This can aid in compensating for space created as the beans are ground, such as space formed as the whole beans 415 are ground and the ground coffee passes through the openings in the movable grinding element 414. In some embodiments, moving (e.g., raising) the movable grinding element 414 relative to the stationary grinding element 412 aids in applying pressure on the whole coffee beans 415, which can increase the force applied to the whole beans 415 and facilitate grinding. In some variants, the movable grinding element 414 is moved in such a way as to maintain a generally constant or increasing grinding pressure on the whole beans 415 during a portion of the grinding operation. Similar to the discussion above, some variants, are configured to decrease, or increase and decrease, the grinding pressure.

In some embodiments, the grinding surfaces 412, 414 can engage. For example, at or near an end of the grinding operation, the movable grinding element 414 can be abutted with the stationary grinding element 412. As is shown, in some variants, the grinding features of the grinding elements 412, 414 nest and/or engage together. For example, the grinding elements of the movable grinding element 414 can be received between the grinding elements of the stationary grinding element 412.

As can be seen in comparing FIGS. 4A and 4B, in some implementations, the same space (e.g., chamber) in the pod 210 can hold the whole coffee beans 415 in one stage of the grinding process, and can hold coffee grounds in another stage of the grinding process. For example, as shown in FIG. 4A, before grinding, the whole coffee beans 415 are positioned in the internal chamber 411a. And as shown in FIG. 4B, after grinding, the coffee grounds are positioned in the internal chamber 411a. This reuse of the same space can allow the pod 410 to be smaller and/or more space-efficient, such as in comparison to the pod 210 discussed above (in which, in some embodiments, the whole coffee beans 415 are positioned in the chamber 211a and the coffee grounds are positioned in a different chamber, the chamber 211b). In some variants, the volume of the chamber in which the whole coffee beans 415 are positioned before grinding is less than or equal to the volume of the chamber in which the coffee grounds are positioned after grinding.

As is also shown in the right side of FIG. 4B, the brewing unit 450 can have a second sealing member 458. For example, the second sealing member 458 can include a gasket, washer, or other element that can form a seal between the pod engagement drive 456 and the upper support 453, thereby reducing the chance of leaks.

In certain implementations, as shown in FIG. 4C, the movable grinding element 414 is configured to tamp the ground coffee. For example, the movable grinding element 414 can be moved downward to compress the coffee grounds located below the movable grinding element 414, such as the coffee grounds that passed through the openings in the movable grinding element 414. In some variants, the movable grinding element 414 reverses direction between the grinding operation (e.g., ascending) and the tamping operation (e.g., descending). Additional details regarding tamping features, or other aspects of the beverage pod, can be found in U.S. Patent Application Publication No. 2014/0272018, filed Feb. 26, 2014, which is incorporated herein by reference in its entirety.

In certain variants, after the grinding and/or compressing operations have been completed, the pod engagement drive 456 and/or the movable grinding element 414 returns to an elevated position, such as is shown in the left side of FIG. 2B. This can facilitate removal of the pod 410 and/or insertion of another pod.

In some embodiments, the brewing unit 450 includes an inlet port 459. The inlet port 459 can be configured to permit liquid (e.g., hot water) to enter the brew chamber for preparation of the beverage. In some implementations, the liquid is introduced after the grinding and/or tamping operations have been completed. As shown in FIG. 4C, some embodiments have a plurality of inlet ports 459. In various embodiments, the liquid can enter the pod 410 and produce a beverage inside the pod 410.

Certain Pods with Rotational Grinders

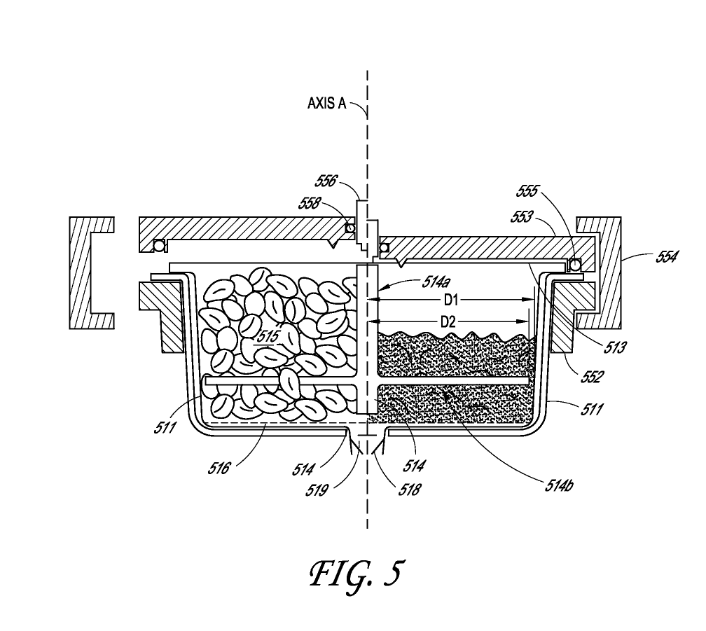

FIG. 5 illustrates a cross-sectional side view of another embodiment of a beverage pod 510 received in an embodiment of a brewing unit 550 of the beverage preparation machine of FIG. 1. In many respects, the pod 510 resembles or is identical to the pods 210 and/or 410 discussed above, with certain differences described below. Likewise, in many respects, the brewing unit 550 is similar or identical to the brewing units 250 and/or 450 discussed above, with certain differences described below. The left portion of FIG. 5 shows the pod 510 and brewing unit 550 in a state before grinding, such as just after the pod 510 has been inserted into the brewing unit 550. The right portion of FIG. 5 shows the pod 510 and brewing unit 550 in a state during or after grinding.

As illustrated, the pod 510 can include the body portion 511 containing whole coffee beans 515. The pod 510 can include an upper seal 513 that sealingly engages with an upper portion of the pod 510, such as by connecting with an outwardly extending flange of the body portion 511. In certain implementations, the upper seal 513 is configured to be breached, such as by being opened, pierced, torn, and/or ruptured. For example, the upper seal 513 can be breached prior to insertion of the pod 510 into the brewing unit 550, during or after a lid of the brewing unit 550 is closed, and/or during a grinding operation. Some embodiments include one or more of a filter 516, restrictor 517, directing element (e.g., a collimator 518), and/or outlet valve 519.

In several embodiments, the brewing unit 550 includes a nest 551, which can receive and/or support the pod 510. For example, an outwardly extending flange of the body portion 511 of the pod 510 can be supported by a shoulder of the nest 551. In some implementations, the nest 551 provides sufficient structural support to the pod 510 so as to enable the pod 510 to be subjected to elevated internal pressures without failing (e.g., unintentionally bursting or otherwise opening). For example, in some embodiments, the nest 551 provides support such that the inside of the pod 510 can be pressurized to at least about 9 bars of pressure.

The nest 551 can be supported by a lower support 552 and/or an upper support 553. In some variants, one or both of the supports 552, 553 is configured to breach the pod 510, such as with one or more piercing members (e.g., teeth, needles, pointed elements, etc.) and/or scoring members. The supports 552, 553 can be secured with a nest clamp 554. A sealing member 555 can provide a generally liquid tight and/or generally gas-tight seal during the beverage preparation operation. As shown, in some implementations, the brewing unit 550 includes a pod engagement drive 556 that can engage with the pod 510, as is discussed in more detail below. A second sealing member 558, such as a gasket or washer, can form a seal between the pod engagement drive 556 and the upper support 553, thereby reducing the chance of leaks. An inlet port (not shown) can provide a passage for liquid to enter the brew chamber for preparation of the beverage.

FIG. 5 also illustrates that the pod 510 can include a movable grinding element 514. The movable grinding element 514 can include a riser 514a, which can extend through the beans 515. The movable grinding element 514 can also include one or more grinding features 514b, such as a plurality of sharp or dull blades, arms, paddles, wings, or the like. As shown, in some embodiments, the grinding features 514b are connected with and/or extend radially outwardly from the risers 514a. For example, in a plane of one or more of the grinding features 514b, the radius of the pod 510 can be D1 and the one or more of the grinding features 514b can extend from an axis A (e.g., the axial centerline of pod 510 and/or the riser 514a) by a radial distance D2. In certain embodiments, the ratio of D2/D1 is at least about: 0.60, 0.75. 0.80, 0.85, 0.90, 0.95, 0.98, values between the aforementioned values, or other values. As shown, the grinding features 514b can be positioned in a lower portion of the pod 510, such as adjacent to the bottom internal surface of the pod 510. This can position the grinding features 514b in a location such that the whole beans 515 are encouraged toward the grinding features 514b, such as by force of gravity. The grinding features 514b can be shaped in such a way as to encourage the whole coffee beans 515 into contact with the grinding features 514b and/or to promote a flow of the whole coffee beans 515 during the grinding process. This can facilitate a generally uniform particle size of the coffee grounds and/or can reduce or eliminate stratification of the coffee grounds. As discussed in more detail below, in some implementations the movable grinding element 514 can act as a screwpump, which can encourage the whole coffee beans 515 toward the grinding features 514b.

In various embodiments, the movable grinding element 514 is configured to move (e.g., rotate, vibrate, tilt, or otherwise move) relative to the body portion 511 and/or the whole beans 515. For example, the movable grinding element 514 can be engaged with, and/or driven by, a pod engagement drive 556 of the brewing unit 550. In various embodiments, the pod engagement drive 556 rotates the movable grinding element 514 inside the pod 510, such as about the axis A. This can rotate the grinding features 514b among the beans 515, thereby grinding the beans 515 into coffee grounds in the pod 510. In certain embodiments, the grinding features 514b rotate at a speed of at least about 1,000 RPM and/or less than or equal to about 20,000 RPM.

In some implementations, the movable grinding element 514 (e.g., the riser 514a and the grinding features 514b) are configured to move generally vertically inside the pod 510. For example, the pod engagement drive 556 of the brewing unit 550 can couple with the movable grinding element 514 in such a way that vertical movement of the pod engagement drive 556 vertically moves the movable grinding element 514, such as similar to the engagement between the pod engagement drive 456 and the movable grinding element 414 described above. In some implementations, vertical movement of the movable grinding element 514 can facilitate grinding of the whole beans 515, such as by rotating the grinding features 514b at different elevations within the pod 510 during the grinding operation. In some implementations, the grinding features 514b are moved vertically in a tamping operation, such as similar to the tamping functionality of the movable grinding elements 214 and/or 414 described above. For example, after grinding, the grinding features 514b can be pressed against the ground coffee to tamp the ground coffee.

In some embodiments, the grinding features 514b are made of a relatively strong and/or hard material, such as in comparison to the hardness of whole coffee beans. For example, the grinding features 514b can be made of metal (e.g., aluminum or stainless steel), hard plastic (e.g., polystyrenes, nylons, acetals, polyetherimides (e.g., Ultem™), acrylics, phenolics, etc.), or other materials. Certain embodiments have grinding features 514b made of a composite, such as a substrate (e.g., carbon fiber, glass particles or fibers, aramid or para-aramid (e.g., Kevlar™), cellulose, aluminum, stainless steel, carbon nanotubes, etc.) reinforced and/or bound with a thermoset resin (e.g., epoxy, nylon, polyester, etc.). For example, the grinding features 514b can be made of an epoxy carbon fiber. In some embodiments, the grinding features 514b have a hardness of at least about 50, at least about 70, at least about 90, or at least about 100 on the Rockwell R scale.

In certain embodiments, the grinding features 514b are made of relatively soft and/or pliable materials, such as wood or soft plastics (e.g., polylactic acid or thermoplastics, such as polytetrafluoroethylene or polypropylene). Surprisingly, even grinding features 514b made of relatively soft and/or pliable materials have been found to be able to grind the whole coffee beans 515 in embodiments of the pod 510. For example, it has been determined that a grinding feature made from a tapered bamboo rod, having a maximum diameter of about 6.5 mm and a minimum diameter of about 3.2 mm, was able to grind the whole coffee beans 515 at a rotational speed of about 10,000 RPM. In some embodiments, the Janka hardness of the grinding features 514b is less than or equal to about 1,500 pounds of force. In some embodiments, the grinding features 514b have a hardness of less than or equal to about 90, about 70, or about 50 on the Shore A Durometer scale.

In some variants, the movable grinding element 514 includes one or more helical fins. The fins can be configured to spin relative to the body portion 511, which causes the fins to act as a screwpump. In some implementations, the screwpump can drive the whole beans 515 toward and/or against a grinding surface of the pod 510, such as a bottom wall of the pod 510.

### Certain Outlet Valves

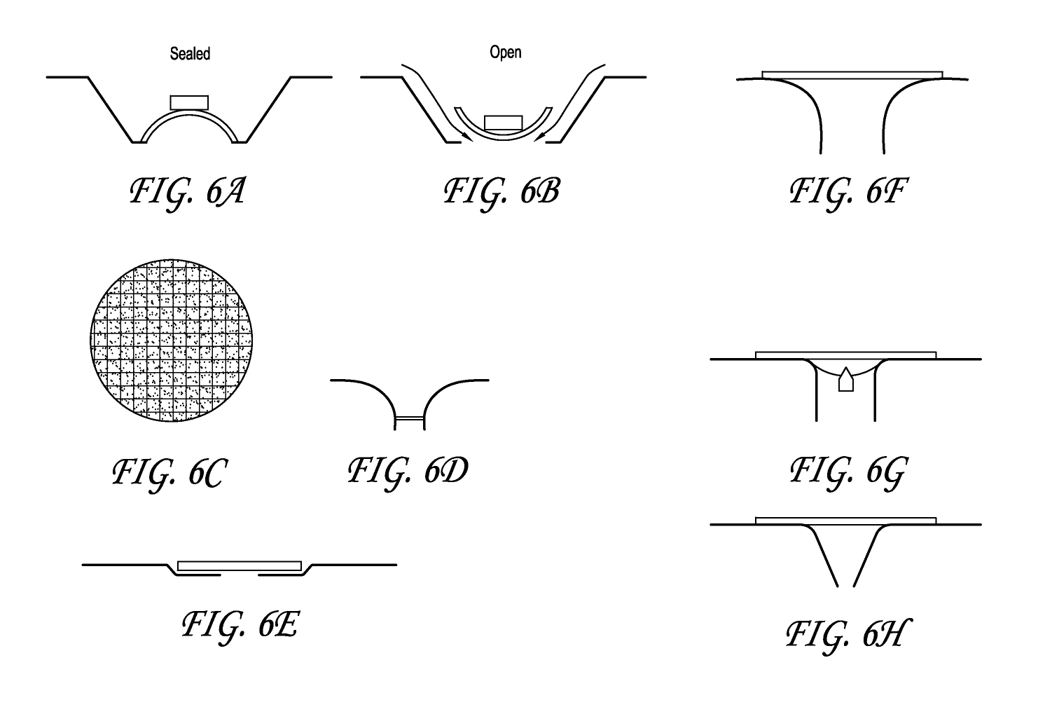

FIGS. 6A-6H illustrate schematic views of various example outlet valves that can be included in any of the pods 210, 410, 510 or as an independent feature in a pod configuration. As previously discussed, the outlet valve can be normally closed, which can inhibit or prevent air from passing or entering the pod and/or can facilitate pressurizing the inside of the pod. During the beverage preparation operation, the outlet valve can open to allow the beverage to be dispensed out of the pod.

With reference to FIGS. 6A-6E, examples of temperature activated outlet valves are illustrated. Temperature activated outlet valves are configured to open in response to at least a threshold temperature being reached inside the pod. In various embodiments, the threshold temperature is reached during the beverage preparation operation, such as due to the introduction of hot water into the pod. The threshold temperature can be at least about: 85° C., 90° C., 95° C., 100° C., values between the aforementioned values, or other values.

FIGS. 6A and 6B illustrate a bi-material outlet valve, which changes between open and closed states based on the different thermal expansion rates of two different materials. In some embodiments, the bi-material valve is made of two types of metals, two types of plastics, one metal and one plastic, other materials, or other combinations of materials. In FIG. 6A, the valve is closed, thereby inhibiting or preventing air and liquid from passing through the valve. In FIG. 6B, response to at least the threshold temperature being reached inside the pod, the valve has opened, thereby allowing liquid (e.g., the beverage) to pass through the valve and out of the pod. As shown, the outlet valve can be a disk valve.

FIGS. 6C and 6D show top and side views of an example of an outlet valve that includes a substrate impregnated with a blocking material (e.g., a meltable and/or dissolvable material). In some embodiments, the substrate is made of metal, plastic, paper or cellulose, or another material. In the example shown, the substrate is a mesh (e.g., a plastic mesh) that is impregnated with a material, thereby blocking the holes in the mesh. The blocking material can melt during the beverage preparation operation, such as due to contact with hot water, thereby removing the blockage in the holes so that the beverage can flow out of the pod. Various materials can be used for the blocking material, such as salt, sugar, gelatin, or cellulose. In some embodiments, the blocking material is carried away with the beverage as the beverage exits the pod. In various implementations, the blocking material is edible, such as a food-grade wax.

FIG. 6E shows an example of thermal shear outlet valve. The valve includes a film that is joined with (e.g., adhered to) the pod, such as to a lip surrounding the opening in the bottom of the pod. During the beverage preparation, the film shrinks as the temperature in the pod increases. This can cause the film to shear or otherwise break away from the pod, thereby opening the valve.

In some embodiments, the outlet valve is mechanically activated. For example, as shown in FIG. 6F, the outlet valve can include an opening sealed with a plate or sheet (e.g., on the bottom surface of the pod). The plate or sheet can contact a structure in the brewing unit, such as a sharp or pointed tip. This can dislodge and/or cut or tear the plate or sheet, thereby opening the valve. In some implementations, the contact occurs when the pod is being inserted into the brewing unit. In some variants, the contact occurs after liquid has been introduced into the pod. For example, the brewing unit can be configured to move the structure into contact with the plate or sheet at a certain stage in the beverage preparation operation, such as at or near the conclusion of the liquid being introduced into the pod.

Certain embodiments include a pressure activated outlet valve. For example, as illustrated in FIG. 6G, the outlet valve can include a membrane positioned across an opening. As the pressure builds in the pod, the membrane deflects. In some embodiments, this deflection opens the valve. In some embodiments, the membrane deflects into contact with a stationary structure of the pod (not shown), which cuts or tears the membrane and thus opens the valve. In FIG. 6H, the membrane has a portion with a reduced thickness, such as at a radially central region of the membrane. The reduced thickness portion can rupture in response to the inside of the pod reaching a certain pressure, such as at least about: 7 bars, 9 bars, 11 bars, or other values.

### Certain Collapsible Pods

FIGS. 7A-7D show partial cross-sectional side views of an embodiment of a beverage pod 710 that is configured to collapse in a brewing unit 750. In many respects, the pod 710 resembles or is identical to the pod 210 discussed above, with certain differences described below, and the brewing unit 750 resembles or is identical to the brewing unit 250 discussed above, with certain differences described below. As noted above, any feature, component, or step disclosed in any embodiment in this specification can be used in any other embodiment, or omitted. For example, the collapsible features and concepts described below can be used in any of the embodiments or be used as an independent feature in a pod configuration.

In various implementations, collapsing the pod reduces the size (e.g., height) of the pod, which can reduce the volume that the pod occupies, such as in a refuse receptacle. In some variants, collapsing the pod can reduce the internal volume of the pod, which can aid in building-up pressure inside pod (e.g., to at least about 9 bars). In some embodiments, collapsing the pod facilitates grinding, such as by encouraging the whole beans toward one or more of the grinding elements and/or reducing the distance between the grinding elements.

FIG. 7A shows the pod 710 in the brewing unit 750, such as just after being inserted into the brewing unit. As shown, the pod 710 can include a body portion 711 with an internal chamber 711a containing whole coffee beans 715. The pod 710 can include a first (e.g., stationary) grinding element 712 and a second (e.g., moving) grinding element 714. In some embodiments, the body portion 711 includes a second internal chamber 711b, which can be positioned below the stationary grinding element 712.

As illustrated, the body portion 711 can include an engagement feature, such as a flange or shoulder 711c. In some embodiments, as shown, the shoulder 711c can provide a transition between different diameters of the pod 711. As described in more detail below, the shoulder 711c can engage with a portion of the brewing unit 750 to facilitate collapse of the pod 711.

FIG. 7A also shows that the brewing unit 750 can include a nest 751. The nest 751 can receive a portion of the pod 710. For example, as illustrated, the nest 751 can receive a lower portion of the pod 710, such as a portion below the shoulder 711c. In various embodiments, the nest 751 provides structural support for some, but not all, of the pod 710. For example, the nest 751 can provide structural support for a lower and/or radially inward portion of the pod 710, but not for an upper and/or radially outward portion of the pod 710. For example, in some variants, the portion of the pod 710 that is at and/or above the shoulder 711c is not supported by the nest 751. In certain embodiments, when the pod 710 is received in the nest 751, the shoulder 711c engages with (e.g., abuts and/or rests on) an end 751a of the nest 751. In some variants, the shoulder 711c engages with the end 751a only after a compressive force is applied to the pod 710, as described more fully below. In some implementations, the nest 751 has a length L1 that is less than or equal to the corresponding length L2 on the pod 710.

The brewing unit 750 can also include a lower support 752. In some embodiments, the lower support 752 connects with an intermediate and/or lower portion of the nest 751. The lower support 752 can extend radially outward from the nest 751. As shown, a recess 752a can be located radially between the nest 751 and the lower support 752.

During use, such as during the grinding operation as shown in FIG. 7B, the pod 710 can be compressed against the brewing unit 750. For example, a generally downward force F can be applied to the pod 710. In some embodiments, the force F is applied to the pod 710 with an upper support 753 of the brewing unit 750. As shown, the force F can cause a portion of the pod 710 to deform, such as by bending and/or buckling. In some embodiments, the engagement between the shoulder 711c and the nest 751 provides structural support to some of the pod 710, which can reduce the likelihood of deformation of the pod 710 below and/or radially inward of the shoulder 711c. On the other hand, in some embodiments, the engagement between the shoulder 711c and the nest 751 can increase the likelihood of deformation of the pod 710 above and/or radially outward of the shoulder 711c. For example, the end 751a of the nest 751 can act as a pivot region, around which an upper and/or intermediate portion of the pod 710 deflects. As shown, in various embodiments, the deflected portion of the pod 710 can be received in the recess 752a.

In some implementations, the brewing unit 750 collapses the pod 710 during the grinding operation. For example, the brewing unit 750 can include a pod engagement drive 756 that engages with the movable grinding element 714 of the pod 710, which can facilitate grinding the whole beans 715 into coffee grounds. In some implementations, similar to the discussion of the pod engagement drive 256 above, the pod engagement drive 756 descends in the pod 710. In certain variants, concurrently with the descending movement of the pod engagement drive 756, or after, the collapsing force is applied to the pod 710, thereby collapsing a portion of the pod 710. For example, the pod engagement drive 756 can begin descending into the pod 710, and the upper support 752 can begin applying a downward force on the pod 710 a period of time later, such as at least about: 5 seconds, 15 seconds, 30 seconds, 1 minute, 2 minutes, 5 minutes, values between the aforementioned values, or other values.

In the embodiment illustrated, the ground coffee passes through openings in the stationary grinding element 712 and accumulates in the second internal chamber 711b. In some variants, the collapsing of the pod 710 facilities movement of the ground coffee into the second internal chamber 711b, such as by pushing the coffee grounds through the openings. As shown, the grinding elements 712, 714 can be in abutment after the collapsing operation. In some embodiments, after the collapsing operation, the internal chamber 711a has substantially no volume, or has less than about 10% of its uncollapsed volume.

FIG. 7C illustrates the pod 710 and brewing unit 750 at or near the end of the grinding and/or collapsing operation. As shown, a deformed portion 711d of the pod 710 has been received in the recess 752a. In certain implementations, the upper support 753 engages with the lower support 752, which can provide a closed brew chamber that is ready for an introduction of liquid to prepare the beverage. A sealing member 755 can be compressed between the supports 752, 753 to provide a generally liquid tight and/or generally gas-tight seal.

FIG. 7D shows a portion of the pod 710 in the uncollapsed and collapsed states. As shown, in some embodiments, the deformed portion 711d of the pod 710 includes a folded or doubled-over portion. In some embodiments, the deformed portion 711d in the recess 752a substantially conforms to the shape of the recess 752a. In certain embodiments, the recess 752a and/or the deformed portion 711d are configured to facilite removal of the deformed portion 711d from the recess 752a. For example, the recess 752a and/or the deformed portion 711d can have a radial width that is greater at an upper portion than at a lower portion. This can allow the deformed portion 711d to be vertically removed from the recess 752a, which can aid in maintaining the ability to vertically remove the pod 710 from the brewing unit 750. In some variants, the recess 752a is generally frustoconically shaped, with the larger end located above the smaller end.

As described above, collapsing the pod 710 can reduce the height of the pod 710, in comparison to the uncollapsed height of the pod 710. For example, the collapsing displacement CD of the pod 710 can be at least about: 5 mm, 10 mm, 15 mm, 20 mm, 25 mm, values between the aforementioned values, or other values. In some embodiments, the ratio of the overall collapsed height to the overall uncollapsed height (measured between the same points as the overall collapsed height) of the pod 710 is less than or equal to about: 0.70, 0.60, 0.50, 0.40, 0.30, values between the aforementioned values, or other values.

### Certain Other Features

In various embodiments, the grinding elements (e.g., movable and stationary) are part of the pod. For example, in several embodiments, the grinding elements are not removable and/or detachable from the pod. In some variants, the grinding elements are sealed inside the pod. For example, in some implementations, the grinding surfaces are sealed from the ambient environment (e.g., ambient air cannot access the grinding surfaces before the upper seal is breached or removed). In several embodiments, after the pod has been used to prepare a beverage, the pod (including the grinding surfaces) is discarded. As indicated above, in various implementations, the grinding elements are part of the pod, not the beverage preparation machine. In certain variants, the pod engagement drive of the brewing unit does not contact and/or directly grind the whole coffee beans.

In some embodiments, the upper seal is configured to deform. In some embodiments, the upper seal is configured to deform by stretching or unfolding. For example, the upper seal can be sufficiently stretchable to allow the pod engagement drive to enter into the pod. In some embodiments, the upper seal is sufficiently stretchable that the pod engagement drive can move the movable grinding element toward and/or into abutment with the stationary grinding element. Further, in some variants, the upper seal is sufficiently stretchable to allow tamping of the coffee grounds, such as is described above. In some embodiments, the upper seal is configured to stretch, without ripping, along the axial axis of the pod at least about: 5 mm, 10 mm, 15 mm, 20 mm, 25 mm, values between the aforementioned values, or other values. In some variants, the upper seal is configured to stretch at least about 10 mm and/or less than or equal to about 20 mm along the axial axis of the pod. Some implementations can stretch up to about 30 mm along the axial axis. In some embodiments, the upper seal can be configured to stretch at least about 50% of an overall height of the pod. In various embodiments, the upper seal is configured to deform without the upper seal being removed or pierced. In certain implementations, the upper seal is configured to deform without the upper seal separating from a rim of the pod.

In certain embodiments, the pod includes a baffle (not shown), such as a sheet or disk of metal foil, plastic, or otherwise. The baffle can be positioned over the outlet aperture to restrict the amount, and/or divert the flow, of beverage discharged through the outlet spout. In some implementations, the baffle is made of a generally liquid impermeable material and includes perforations, holes, grooves, channels, or otherwise to permit the liquid to flow therethrough. In some variants, the baffle is configured to direct the beverage to flow around the baffle. For example, the baffle can be configured to encourage the extracted beverage to flow generally around the sides of the baffle and/or under the baffle (e.g., between the baffle and an inside surface of the bottom of the body portion of the pod). In some embodiments, the flow is forced to go around the baffle and travel generally horizontally to reach the outlet aperture.

The beverage preparation machine can include various electronics, such as a controller in electronic communication with one or more sensors. Some embodiments include a temperature sensor to detect the temperature of the liquid introduced into the brewing unit and/or of the beverage. Certain embodiments include a pressure sensor that senses the pressure inside the pod. Some variants include a pressure sensor that senses the grinding pressure (e.g., the pressure being applied to the beans during the grinding operation). Some embodiments are configured to adjust the position of the pod engagement drive, and thus the movable grinding element, to maintain a grinding pressure.

### Certain Terminology

As used herein, the term “beverage” has its ordinary and customary meaning, and includes, among other things, any edible liquid or substantially liquid substance or product having a flowing quality (e.g., juices, coffee beverages, teas, frozen yogurt, beer, wine, cocktails, liqueurs, spirits, cider, soft drinks, flavored water, energy drinks, soups, broths, combinations of the same, or the like).

The term “pod,” as used herein, has its ordinary and customary meaning, and includes, among other things, cartridges, capsules, canisters, pucks, pads, and the like, whether or not such pods are capable of and/or configured to be pierced or otherwise ruptured to form an inlet into and/or outlet from the pod.

As used herein, the term “single-serving” has its ordinary and customary meaning, and includes, among other things, a portion of beverage that is customarily consumed by one person. For example, some single-serving beverage pods are configured to produce less than or equal to about 20 fluid ounces (about 600 milliliters) of beverage.

The term “beverage component or precursor,” as used herein, has its ordinary and customary meaning. Although certain embodiments have been disclosed that include a single beverage component or precursor, the term “beverage component or precursor” is not limited to only a single component. Rather, the beverage component or precursor can comprise one component (e.g., coffee) or a plurality of components (e.g., coffee and a sweetener).

The term “brew,” as used herein, has its ordinary and customary meaning, such as meaning to prepare. Terms such as “brew” and “brewing” are not limited to pertaining to only drip coffee beverages (e.g., filtered coffee or pour-over coffee beverages). Rather, such terms can pertain to a wide variety of beverages, such as espresso beverages, tea, juice, and other beverages.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes, or tends toward, a particular value, amount, or characteristic. For example, as the context may dictate, the term “generally parallel” can mean something that departs from exactly parallel by less than or equal to 15°, and the term “generally perpendicular” can mean something that departs from exactly perpendicular by less than or equal to 15°.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Although this disclosure describes certain embodiments and examples of beverage pods, many aspects of the methods and devices shown and described in the present disclosure may be combined differently and/or modified to form still further embodiments or acceptable examples. All such modifications and variations are intended to be included herein within the scope of this disclosure. Indeed, a wide variety of designs and approaches are possible and are within the scope of this disclosure. For example, although certain embodiments are described as having a stationary grinding element and a movable grinding element, some embodiments include two movable grinding elements, such as a descending grinding element and an ascending grinding element. As another example, although certain embodiments include a stationary grinding element, the stationary grinding element need not be completely motionless (e.g., in some embodiments the stationary grinding element vibrates, rotates, and/or oscillates). As a further example, although some embodiments have been disclosed in which liquid water is introduced into the pod, the introduction of other liquids (e.g., milk) and/or other phases (e.g., steam) is contemplated as well. As yet a further example, while some embodiments have been described in connection with ascending and/or descending grinding elements, certain embodiments have grinding elements that translate in a sideways (e.g., generally horizontal) direction. While illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage pods have been disclosed. Although the beverage pods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

The following is claimed:

1. A beverage pod for the preparation of a single serving of a beverage, the beverage pod comprising:
a body portion containing whole coffee beans;
a movable grinding element positioned in the body portion, the movable grinding element configured to move relative to the body portion and to grind the coffee beans into coffee grounds inside the beverage pod;
wherein the beverage pod is configured to receive an introduction of liquid, the liquid mixing with the coffee grounds to prepare the beverage inside the pod.

2. The beverage pod of claim 1, further comprising a stationary grinding element positioned in the body portion.

3. The beverage pod of claim 2, wherein the movable grinding element is configured to move toward the stationary grinding element.

4. The beverage pod of claim 3, wherein the movable grinding element is configured to descend in the body portion relative to the stationary grinding element.

5. The beverage pod of claim 3, wherein the movable grinding element is configured to ascend in the body portion relative to the stationary grinding element.

6. The beverage pod of claim 2, wherein the movable grinding element and the stationary grinding element are configured to together form a bun grinder.

7. The beverage pod of claim 1, wherein the movable grinding element comprises a plurality of blades.

8. The beverage pod of claim 7, wherein the blades are made of bamboo.

9. The beverage pod of claim 2, wherein the movable grinding element or the stationary grinding element further comprises openings configured to allow the ground coffee to pass through the openings.

10. The beverage pod of claim 1, wherein the pod is configured to dispense the beverage from an outlet directly into a cup.

11. The beverage pod of claim 10, wherein the outlet comprises a collimator.

12. The beverage pod of claim 10, wherein the outlet comprises a valve configured to open when the pressure inside the pod is greater than or equal to 9 bars.

13. The beverage pod of claim 1, further comprising a filter configured to inhibit the coffee grounds from exiting the pod.

14. The beverage pod of claim 1, further comprising a cover that is sealed with the body portion.

15. The beverage pod of claim 14, wherein the cover is configured to be removed from the body portion.

16. The beverage pod of claim 14, wherein the cover is configured to be penetrated by a piercing member.

17. The beverage pod of claim 1, wherein the whole coffee beans are sealed inside the beverage pod.

18. The beverage pod of claim 17, wherein the whole coffee beans are in a generally oxygen free environment.

19. A beverage preparation system comprising:
the beverage pod of claim 1; and
a beverage preparation machine configured to receive the beverage pod and to introduce the liquid into the beverage pod.

20. The beverage preparation system of claim 19, wherein the beverage preparation machine further comprises a pod engagement drive configured to engage with the movable grinding element of the pod.

21. The beverage preparation system of claim 20, wherein the pod engagement drive is configured to rotate the movable grinding element.

22. The beverage preparation system of claim 19, wherein the beverage preparation machine is configured to apply a force to the pod to collapse the pod inside the beverage preparation machine.

23. A method of manufacturing a beverage pod for the preparation of a single serving of a beverage, the beverage pod adapted to be inserted into a beverage preparation machine and to receive an introduction of liquid to prepare a beverage in the beverage pod, the method comprising:
obtaining a body portion having an inside;
inserting a grinding element in the inside of the body portion;
inserting whole coffee beans in the inside of the body portion; and
sealing the body portion to inhibit air from accessing the inside of the body portion.

24. The method of claim 23, further comprising inserting a second grinding element in the inside of the body portion.

25. A method of preparing a beverage, the method comprising:
receiving, into a beverage preparation machine, a beverage pod comprising whole coffee beans and a grinding element;
driving the grinding element of the beverage pod with the beverage preparation machine;
grinding the whole beans inside the beverage pod to form coffee grounds;
introducing liquid into the pod;
mixing the liquid with the coffee grounds to form a beverage inside the pod; and
dispensing the beverage from the pod.

26. The method of claim 25, wherein driving the grinding element comprises rotating the grinding element with respect to the whole coffee beans.

27. The method of claim 25, wherein the beverage pod further comprises a second grinding element, and wherein driving the grinding element comprises moving the grinding element toward the second grinding element.
